(19) United States
(12) Patent Application Publication
(10) Pub. No.: US 2008/0186186 A1
(43) Pub. Date: Aug. 7, 2008

(54) APPARATUS AND METHOD FOR SELECTIVELY PERMITTING AND RESISTING READING OF RADIO FREQUENCY CHIPS

(75) Inventor: David F. Campbell, Lancaster, PA (US)

Correspondence Address: Eckert Seamans Cherin & Mellott, LLC, 600 Grant Street, 44th Floor, Pittsburgh, PA, 15219, US

(73) Assignee: OpSec Security Group, Inc., Denver, CO (US)

(21) Appl. No.: 11/671,754

(22) Filed: Feb. 6, 2007

(51) Int. Cl. G08B 13/14

(52) U.S. Cl. 340/572.8

(57) ABSTRACT

A shield for use in resisting reading of radio frequency chips includes a flexible non-metallic substrate having a metallic coating. The shield may be incorporated into a book such as a passport, an envelope, a folder, or removably adhered to an article having a radio frequency chip disposed thereon.

### BACKGROUND OF THE INVENTION

1. Field of the Invention

The invention relates to shielding of radio frequency chips. More specifically, the invention provides a shield having a metallic layer deposited on a non-metallic substrate, that may easily be incorporated into books such as passports, envelopes, folders, briefcases, other containers, or other items which may contain a radio frequency chip that must be selectively read or shielded from reading.

2. Description of the Related Art

Radio frequency chips, and particularly radio frequency identification (RFID) chips, are becoming an increasingly popular means of storing information. A typical radio frequency chip is adapted to transmit a radio frequency signal that may be read from a distance of up to about 4 inches away from the chip. Such chips have been proposed to replace bar codes for inventory tracking, and as an additional means of storing information within a passport.

U.S. Patent Application Number US 2004/0224135 A1, filed by R. R. Krebs, on Mar. 8, 2004, discloses printing an RFID antenna using a conductive ink on a core, and including a conductive mesh shield on the same surface as the antenna. The goal is to allow reading of desired RFID tags while resisting the reading of neighboring RFID tags. The core may be dry paper, a resin saturated or untreated Kraft paper, cardboard or card stock, or a synthetic or plastic type material, such as polyester or nylon. The antenna is printed on the core by a technique such as silk screening, flexigraphic, or gravure techniques. Alternatively, it may be painted using a mask, template, or robotic arm. A second core may be placed over the first core to sandwich the antenna therebetween. In some embodiments, a protective shield may be provided by laying a steel mesh on the core, so that the steel mesh is in the same layer as the antenna, and between cores. The shield disclosed by this patent therefore fails to selectively permit or resist reading the RFID tags, and does nothing to resist the unauthorized reading of the RFID tags.

U.S. Pat. No. 4,647,714, issued to H. Goto on Mar. 3, 1987, discloses a composite sheet material for magnetic and electronic shielding. The sheet material comprises an electrodeposited iron foil which is made by electrodepositing iron on an electrodeposition body such as a rotating electro-deposition drum, and then exfoliating the electrodeposited iron layer from the drum. The iron foil may then be plated with an electrically conductive metal such as zinc, tin, nickel, chromium, or copper to resist rust. Alternatively, a lead plating layer may be used for shielding from radioactive rays. A covering layer is adhesively secured over the plated layer. The resulting foil may be adhesively secured where shielding is desired, or incorporated into envelopes and other containers. This patent fails to disclose a non-metallic substrate, and instead requires the additional steps associated with producing the iron foil.

U.S. Pat. No. 6,121,544, issued to J. A. Petsinger on Sep. 19, 2000, discloses an electromagnetic shield made from a soft magnetic alloy which may be sandwiched between two plastic reinforcing shells. The magnetic shielding material is preferably an alloy made from about 80% nickel, with the remainder being iron, molybdenum, chromium, or copper. The shield disclosed in this patent would be too rigid for use in a book such as a passport, having a soft cover.

U.S. Pat. No. 6,726,109, issued to N. Yamagishi et al. on Apr. 27, 2004, discloses a passport with an anti-counterfeit ID chip. The ID chip contains the identity and nationality of the passport holder, and is embedded in a front cover, back cover, or a page containing a photograph and other identification. Shielding of the ID chip is not disclosed within this patent.

U.S. Patent Application Number US 2003/0080917 A1, filed by M. T. Adams et al. on Jul. 12, 2002, discloses surrounding a RFID antenna or circuit with a dielectric material, thereby resisting contact between the RFID circuit and any conductive surfaces with which it may come in contact. This application is therefore directed towards facilitating the reading of an RFID circuit instead of resisting unauthorized reading of the RFID circuit.

U.S. Patent Application Number US 2003/0168514 A1, filed by S. Ratsion et al. on Apr. 25, 2002, discloses a multi-layer cover paper for a booklet such as a passport, containing a radio frequency identification device. This patent fails to disclose any means of resisting unauthorized reading of the RFID device.

Accordingly, there is a need for a shield for radio frequency chips that is both inexpensive to manufacture and sufficiently durable to be incorporated into articles having an expected lifespan of several years. There is a further need for a shield for a radio frequency chip that is sufficiently inexpensive to manufacture to be useful as a single use, disposable item. There is another need for a shield for radio frequency chips that may be easily incorporated into passports, folders, envelopes, or which may be adhesively adhered to an item having a radio frequency chip disposed thereon, without adding a substantial amount of bulk.

### SUMMARY OF THE INVENTION

The above needs and others are met by a shield for radio frequency chips having a metallic coating applied to a non-metallic substrate. The shield may be incorporated into any container for containing an item having an RFID chip thereon or therein, or attached to any item having an RFID chip thereon or therein. For the purpose of this description, removal of the shield from the RFID chip includes any procedure by which the shield and RFID chip are separated a sufficient distance to permit reading the RFID chip, regardless of whether such removal includes the detachment of the shield from any surface to which the shield is attached or incorporated.

The substrate for the shield may be made from polyester, polymeric films such as polystyrene, cellulose, and acetate, or other thin, durable, flexible materials. The metal coating may be aluminum, copper, chromium, or other metal, and may be applied by vacuum coating, or by depositing the coating in the form of a conductive ink.

A shield of the invention may be incorporated within the front cover, back cover, or within any page of a passport or other book. If the book contains a RFID chip, incorporating the shield and RFID chip within different portions of the cover or different pages will position the shield sufficiently close to the RFID chip to interfere with radio frequency waves transmitted by the RFID chip and thereby resist reading the chip, when the book is closed. Opening the book separates the shield and RFID chip sufficiently to permit reading the RFID chip.

In one example embodiment, the RFID chip is secured to one cover portion, for example, the back cover, and the shield is secured to the other cover portion, for example, the front cover. A sheet of page material may be adhesively secured to the inside of the cover, so that both the RFID chip and the shield are disposed between the cover stock and the page material. A spacer may be disposed adjacent to the shield to compensate for the difference in thickness between the shield and the RFID chip, thereby making both cover portions substantially the same thickness.

Alternatively, a shield of the invention may be incorporated within a folder, envelope, a carrying bag or case such as a briefcase, or other container. The shield may be secured to one side of the folder or envelope, or secured between adjacent layers of material forming a side. Examples of containers wherein such a shield is useful include mailing envelopes for credit cards containing RFID chips, internal envelopes containing credit cards having RFID chips, which may then be placed within a mailing envelope or a user's wallet, or legal or medical files having RFID chips incorporated therein to assist within intraoffice file tracking and locating of the files while resisting reading the RFID chips during transportation of the files.

Another embodiment of the shield may be structured to be adhesively secured to an article having an RFID chip disposed thereon. For example, a credit card having an RFID chip may have a shield adhesively secured thereon during mailing. The shield may then be removed by the recipient. The shield may be adhesively secured using either a removable adhesive, or using static cling. In some embodiments, the shield may be applied to the credit card by providing shield material and credit card material in sheets sufficiently large to make several credit cards having shields attached thereon, adhering the sheets together, and then cutting the combined sheets into individual shielded credit cards.

It is therefore an object of the invention to provide a shield for radio frequency chips that is sufficiently inexpensive for single use applications.

It is another object of the invention to provide a shield for radio frequency chips that may be incorporated into articles having an expected life of several years.

It is a further object of the invention to provide a shield for radio frequency chips having a flexible, non-metallic substrate having a metal coating.

It is another object of the invention to provide a shield for radio frequency chips that may be incorporated within a passport so that closing the passport (or other book), brings the shield sufficiently close to the RFID chip to interfere with radio waves transmitted by the RFID chip and thereby resists reading the chip, while opening the passport separates the shield from the RFID chip sufficiently to permit reading the chip.

It is a further object of the invention to provide a shield for radio frequency chips that may be incorporated into mailing envelopes, other envelopes, and file folders.

It is another object of the invention to provide a shield for radio frequency chips that may be removably adhered to an article having a radio frequency chip, thereby resisting reading of the chip until the shield is removed therefrom.

It is a further object of the invention to provide a shield for radio frequency chips that may be fabricated alongside articles containing RFID chips, and adhered to the articles containing RFID chips prior to separating the individual articles from the sheet from which they are manufactured.

It is another object of the invention to provide a shield for radio frequency chips that resists reading the chip when the shield is positioned in a first location with respect to the chip, and permits reading the chip when the shield is removed to a second location with respect to the chip.

These and other objects of the invention will become more apparent from the following description and drawings.

### BRIEF DESCRIPTION OF THE DRAWINGS

FIG. 1 is a schematic edge view of a shield according to the invention.

FIG. 2 is a front schematic view of a shield according to the invention, incorporated within a passport or other book.

FIG. 3 is a bottom edge view of a shield according to the invention, incorporated into the cover of a passport.

FIG. 4 is an edge view of a shield according to the invention, incorporated into the cover of a passport.

FIG. 5 is a front view of another embodiment of a shield according to the invention, showing the shield incorporated into an envelope.

FIG. 6 is a front view of another embodiment of a shield according to the invention, showing the shield incorporated into another envelope.

FIG. 7 is a schematic front view of a credit or identification card having a radio frequency identification chip with which the shield of the invention may be used.

FIG. 8 is a back view of the card of FIG. 7 having a shield of the invention adhered thereto.

FIG. 9 is a top view of a plurality of cards of FIG. 7, prior to cutting into individual cards, and having material for forming a shield of the invention adhered thereto.

Like reference characters denote like elements throughout the drawings.

### DETAILED DESCRIPTION OF THE PREFERRED EMBODIMENTS

Embodiments of the invention provide a shield for use in selectively resisting and permitting the reading of radio frequency chips such as RFID chips.

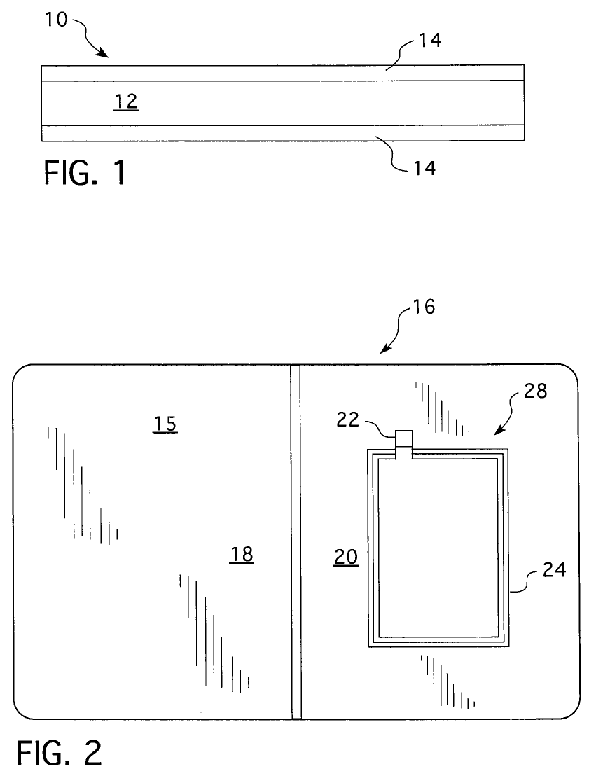

Referring to FIG. 1, a shield 10 includes a flexible nonmetallic substrate 12 having a metallic coating 14. The substrate 12 may be any material having sufficient strength, thinness, and flexibility to be useful in a location where the shield will be used, and which will accept a metallic plating. Preferred substrates include, for example and without limitation, polyester, and polymeric films, such as polystyrene, cellulose, and acetate. The thickness of the substrate 12 is preferably from about 0.00025 to about 0.1 inch, and more preferably from about 0.004 to about 0.006 inch. Preferred metals for use in forming the metal coating 14 include, for example and without limitation, aluminum, copper, nickel, and chromium. The metal coating 14 may be applied to the substrate 12 by vacuum coating or in the form of a conductive ink. The thickness of the metal coating 14 is preferably from about 5 Angstroms to about 10⁵ Angstroms, and more preferably from about 45 Angstroms to about 55 Angstroms.

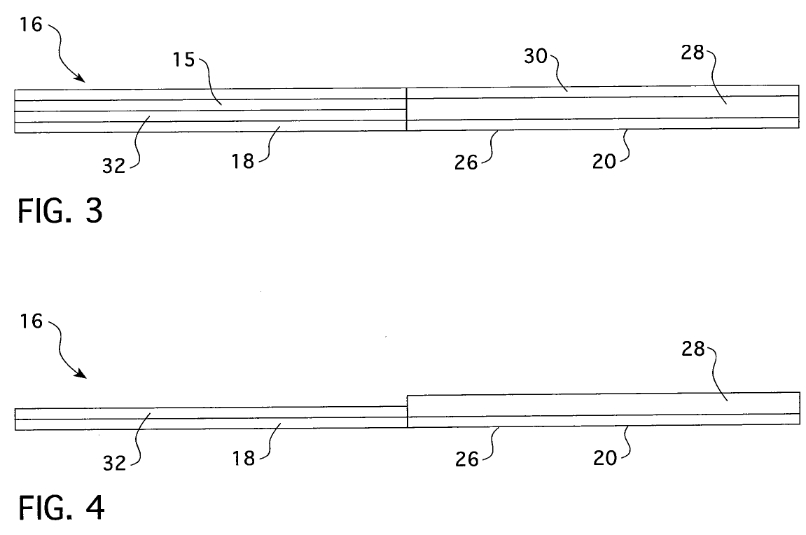

Referring to FIGS. 2-4, the shield 15 is illustrated and incorporated into the cover 16 of a passport. The cover 16 includes a front portion 18 including the shield 15, and a back portion 20 including an RFID chip 22 having an antenna 24. Referring to FIGS. 3-4, the cover 16 includes a sheet of cover stock 26 having the shield 10 adhesively secured to the front cover portion, and the RFID chip assembly 28 (including the RFID chip 22 and the antenna 24) adhesively secured to the back cover portion 20. A sheet of page material 30 may optionally be adhesively secured over the shield 15 and RFID chip assembly 28 so that the shield 15 and RFID chip assembly 28 are secured between the cover stock 26 and page material 30. If desired, a spacer 32 may also be secured between the cover stock 26 and page material 30, to compensate for any difference in thickness between the shield 15 and the RFID chip assembly 28, so that the front cover portion 18 and back cover portion 20 have substantially the same thickness.

Although the shield 15 and RFID chip assembly 28 are illustrated on the front cover portion 18 and back cover portion 20, respectively, these locations could be reversed. Additionally, either the shield 15, the RFID chip assembly 28, or both, may be disposed upon any of the pages in between the front cover portion 18 and back cover portion 20.

In use, closing the cover 16 will bring the shield 15 sufficiently close to the RFID chip assembly 28 to interfere with radio frequency waves transmitted by the RFID chip assembly 28, thereby resisting reading the RFID chip 22. Opening the cover 16 positions the shield 15 sufficiently far from the RFID chip assembly 28 to permit reading the RFID chip 22.

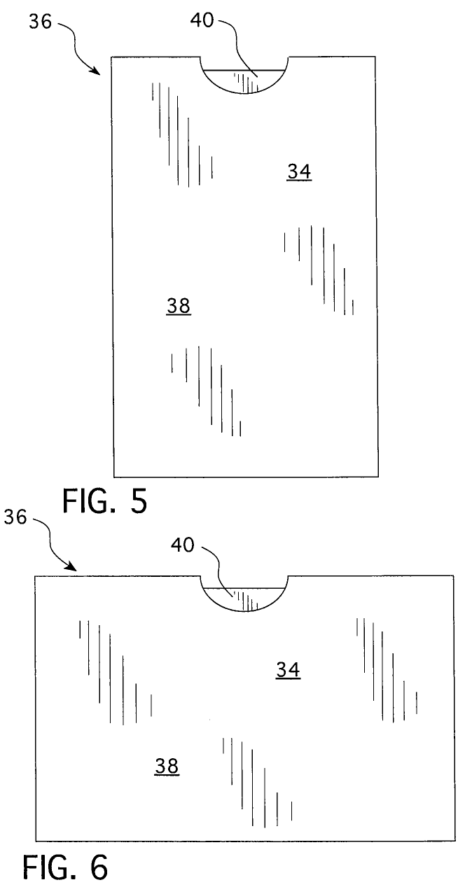

Referring to FIGS. 5-6, another embodiment of the shield 34 is illustrated. The shield 34 is incorporated into an envelope 36 having a pair of sides, one of which, side 38, is shown. The shield 34 is disposed on or within the side 38, so that an article 40 having an RFID chip disposed thereon placed within the envelope 36 will be sufficiently close to the shield 34 to interfere with radio frequency waves transmitted by the RFID chip of the article 40, thereby resisting reading the chip. Reading an RFID chip disposed on the article 40 requires removal of the article 40 from the envelope 36.

From the above description, it will be obvious to those skilled in the art that the envelope 36 could be a mailing envelope, or it could be another envelope placed inside a mailing envelope, with the article 40 inside the envelope 34. This embodiment of the shield 34 is particularly useful for mailing a credit card having an RFID chip to a consumer. Alternatively, the envelope 36 could be a folder containing, for example, legal or medical records. It may be desired to locate and track such folders using RFID chips when the folders are located within the user's office, and to shield such folders from having their RFID chips read when they are removed from the office to protect the confidentiality of the patient or client whose records are contained therein.

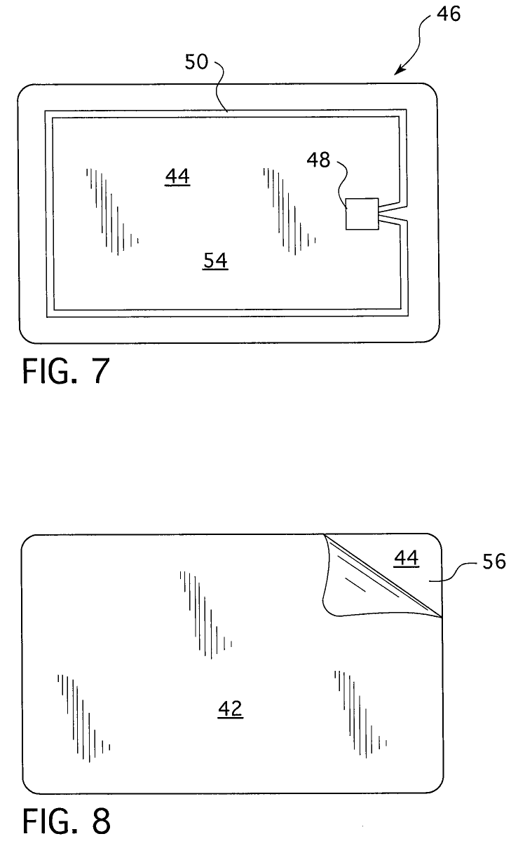

Referring to FIGS. 7-8, another embodiment of the shield 42 is illustrated. The shield 42 is adhesively secured to one side of an article 44 having an RFID chip assembly 46 including an RFID chip 48 and antenna 50 disposed thereon. In the illustrated embodiment, the article 44 is a credit or ID card having the RFID chip assembly 46 disposed on its front surface 54, and the shield 42 adhered to its back surface 56. The location of the shield 42 and RFID chip assembly 46 could be reversed, or the shield 42 and RFID chip assembly 46 could be disposed on the same side of the card 44. The shield 42 may be secured to the card 44 using a removable adhesive. Alternatively, the shield 42 and article 44 may be adapted to accept opposite static electrical charges, thereby adhering the shield 42 to the article 44 by static cling. The shield 42 may thereby be adhered to an article 44 such as a credit card during mailing, thereby resisting reading of the RFID chip 48 during mailing of the credit card 44, thereby resisting identity theft. Upon receipt, the user can peel the shield 42 away from the card 44 and discard the shield 42, as illustrated in FIG. 8.

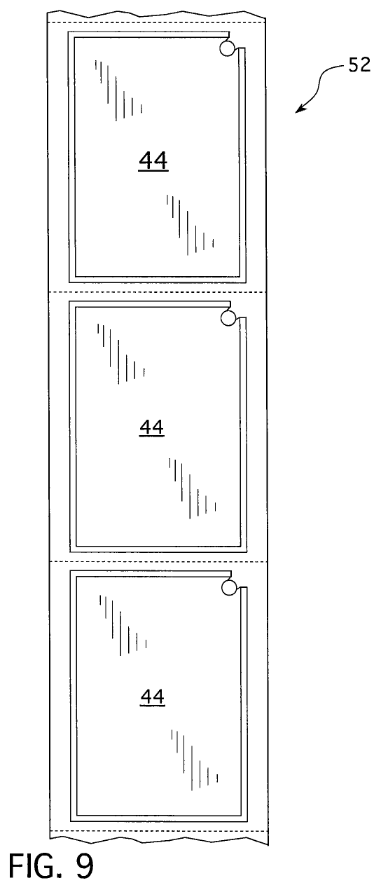

Referring to FIG. 9, a method of making the shield 42 and attaching it to the article 44 is illustrated. The shielding material may be provided as a continuous strip, with the cards 44 also provided as a continuous strip 52. Each of the cards 44 includes an RFID chip assembly 46 disposed thereon. The sheet of shielding material may be adhered to the continuous strip of cards 52 using either a removable adhesive or static cling. The individual cards 44 may then be cut from the strip 52, resulting in each card 44 having a shield 42 secured thereto.

The invention therefore provides a shield for RFID chips that is sufficiently inexpensive for single use applications, and yet sufficiently durable for incorporation into articles having an expected life of several years. The shield may be incorporated with a passport or other book, within an envelope or folder, or adhesively secured to a credit card, identification card, or other article having an RFID chip incorporated thereon, so that reading the RFID chip may be selectively permitted or resisted by separating the shield from the RFID chip, or positioning the shield adjacent to the RFID chip. The shield may be fabricated alongside credit or identification cards containing RFID chips, and adhere to the articles containing RFID chips prior to separating the individual articles from the sheet from which they are manufactured.

While a specific embodiment of the invention has been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

What is claimed is:

1. A shield for a radio frequency chip, comprising a flexible nonmetallic substrate having a metal coating, the shield being structured to be removably retained adjacent to the radio frequency chip, whereby the shield creates interference with radio frequency waves transmitted or received by the radio frequency chip and thereby resists reading the radio frequency chip.

2. The shield according to claim 1, wherein the substrate is a resinous plastic.

3. The shield according to claim 2, wherein the substrate is made from a material selected from the group consisting of polyester and polymeric films.

4. The shield according to claim 3, wherein the polymeric films are selected from the group consisting of polystyrene, cellulose, and acetate.

5. The shield according to claim 1, wherein the thickness of the substrate is about 0.00025 inch to about 0.1 inch, and preferably about 0.004 inch to about 0.006 inch.

6. The shield according to claim 1, wherein the metal coating is selected from the group consisting of aluminum, copper, nickel, and chromium.

7. The shield according to claim 1, wherein the thickness of the metal coating is about 5 Angstroms to about 10⁵ Angstroms, and preferably about 45 Angstroms to 55 Angstroms.

8. The shield according to claim 1, wherein the shield forms one layer within or on a cover or a page of a book.

9. The shield according to claim 1, further comprising means for removably adhering the shield to an object having a radio frequency chip.

10. The shield according to claim 9, wherein the means for removably adhering the shield to an object having a radio frequency chip is an adhesive.

11. The shield according to claim 9, wherein the means for removably adhering the shield to an object having a radio frequency chip include the shield being adapted to retain a static electrical charge, and the object having a radio frequency chip being adapted to retain an opposing static electrical charge.

12. The shield according to claim 1, wherein the shield includes a container structured to contain an object having a radio frequency chip.

13. The shield according to claim 12, wherein the container is selected from the group consisting of an envelope, a folder, and a carrying bag or case.

14. A book having:
a front cover;
a back cover;
a plurality of pages therebetween;
a radio frequency chip disposed on or within a location selected from the front cover, the back cover, or one of the plurality of pages; and
a shield for a radio frequency chip, comprising a flexible nonmetallic substrate having a metal coating, the shield being disposed on or within a location selected from the front cover, the back cover, or one of the plurality of pages, the location of the shield being different from the location of the radio frequency chip, whereby the shield resists reading the radio frequency chip when the book is closed, and permits reading the chip when the book is open.

15. The shield according to claim 14, wherein the substrate is a resinous plastic.

16. The book according to claim 14, wherein the substrate is made from a material selected from the group consisting of polyester and polymeric films.

17. The book according to claim 16, wherein the polymeric films are selected from the group consisting of polystyrene, cellulose, and acetate.

18. The book according to claim 14, wherein the thickness of the substrate is about 0.00025 inch to about 0.1 inch, and preferably about 0.004 inch to about 0.006 inch.

19. The book according to claim 14, wherein the metal coating is selected from the group consisting of aluminum, copper, nickel, and chromium.

20. The book according to claim 14, wherein the thickness of the metal coating is about 5 Angstroms to about 10⁵ Angstroms, and preferably 45 Angstroms to about 55 Angstroms.

21. The book according to claim 14, wherein:
the radio frequency chip is disposed within one of the front cover or the back cover; and
the shield is disposed within the other of the front cover or the back cover.

22. The book according to claim 21, wherein:
the front cover and the back cover are defined by a single piece of cover stock; and
the radio frequency chip and the shield are disposed on the cover stock.

23. The book according to claim 22:
further comprising a single sheet of page material structured to overlap the single piece of cover stock; and
wherein the radio frequency chip and the shield are disposed between the cover stock and page material.

24. The book according to claim 23, further comprising a spacer adjacent to the shield.

25. A container, comprising:
a pair of sides; and
a shield disposed on or within one of the sides for shielding a radio frequency chip, comprising a flexible nonmetallic substrate having a metal coating, whereby the shield creates interference with radio frequency waves transmitted or received by a radio frequency chip disposed within the container, and thereby resists reading the radio frequency chip.

26. The container according to claim 25, wherein the substrate is a resinous plastic.

27. The container according to claim 25, wherein the substrate is made from a material selected from the group consisting of polyester and polymeric films.

28. The container according to claim 27, wherein the polymeric films are selected from the group consisting of polystyrene, cellulose, and acetate.

29. The container according to claim 25, wherein the thickness of the substrate is about 0.00025 inch to about 0.1 inch, and preferably about 0.004 inch to about 0.006 inch.

30. The container according to claim 25, wherein the metal coating is selected from the group consisting of aluminum, copper, nickel, and chromium.

31. The container according to claim 25, wherein the thickness of the metal coating is about 5 Angstroms to about 10⁵ Angstroms, and preferably about 45 Angstroms to about 55 Angstroms.

32. The container according to claim 25, wherein the container is selected from the group consisting of an envelope and a folder.

33. A method of making a shield, comprising:
providing a flexible nonmetallic shield substrate; and
providing a metallic coating over the nonmetallic substrate.

34. The method according to claim 33, wherein the metallic coating is deposited on the substrate by vacuum deposition.

35. The method according to claim 33, wherein the metallic coating is deposited as a conductive ink.

36. The method according to claim 33, wherein providing a metallic coating is performed until a thickness of at least about 5 Angstroms is reached within the metallic coating.

37. The method according to claim 33, further comprising securing the shield within or on a front cover, a back cover, or a page of a book having a radio frequency chip secured to another of the front cover, back cover or another page.

38. The method according to claim 37, further comprising:
providing a sheet of cover stock;
providing a sheet of page material;
adhering a radio frequency chip on the cover stock;
adhering the shield on the cover stock; and
folding the cover to define a front cover portion and a back cover portion, one of the front cover portion or back cover portion containing the radio frequency chip, and the other of the front cover portion and back cover portion containing the shield.

39. The method according to claim 38, further comprising:
providing a sheet of page material; and
adhering the page material over the cover stock, radio frequency chip, and shield so that the radio frequency chip and the shield are disposed between the page material and the cover stock.

40. The method according to claim 39, further comprising placing a spacer adjacent to the shield, between the cover stock and page material.

41. The method according to claim 33, further comprising securing the shield to an envelope or folder structured to contain an item having a radio frequency chip.

42. The method according to claim 33, further comprising providing a means to adhere the shield to an item having a radio frequency chip.

43. The method according to claim 42, wherein the means to adhere the shield to an item having a radio frequency chip are selected from the group consisting of:
an adhesive; and
the shield being adapted to retain a static electrical charge, and the object having a radio frequency chip being adapted to retain an opposing static electrical charge.

44. The method according to claim 43, further comprising:
providing sufficient nonmetallic flexible substrate material to form a plurality of shields from a single sheet of substrate material;
providing a metallic coating over the nonmetallic substrate material to form shielding material;
providing a single sheet having a plurality of radio frequency chips thereon;
adhering the shielding material to the sheet having a plurality of radio frequency chips; and
cutting the shielding material and the sheet having a plurality of radio frequency chips to form a plurality of articles, each article having a radio frequency chip and a shield.

45. A method of shielding a radio frequency chip from unauthorized reading, comprising:
providing a shield comprising a flexible nonmetallic substrate having a metal coating, the shield being structured to be removably retained adjacent to the radio frequency chip; and
placing the shield in sufficiently close proximity to the radio frequency chip to create interference with radio frequency waves transmitted or received by the radio frequency chip, thereby resists reading the radio frequency chip.

46. The method according to claim 45, further comprising:
providing a radio frequency chip disposed on or within a front cover, a back cover, or a page of a book;
providing a shield comprising a flexible nonmetallic substrate having a metal coating in another of the front cover, the back cover, or another of the pages of the book; and
selectively opening or closing the book, whereby closing the book places the shield in sufficiently close proximity to the radio frequency chip to create interference with radio frequency waves transmitted or received by the radio frequency chip, thereby resists reading the radio frequency chip, and opening the book moves the shield sufficiently far away from the radio frequency chip to permit reading the chip.

47. The method according to claim 45, further comprising:
securing the shield to an envelope or folder structured to contain an item having a radio frequency chip; and
selectively placing the item in or removing the item from the envelope or folder, whereby placing the item in the envelope or folder places the shield in sufficiently close proximity to the radio frequency chip to create interference with radio frequency waves transmitted or received by the radio frequency chip, thereby resists reading the radio frequency chip, and removing the item from the envelope or folder moves the shield sufficiently far away from the radio frequency chip to permit reading the chip.

48. The method according to claim 45, further comprising:
providing a means to adhere the shield to an item having a radio frequency chip; and
selectively adhering the shield to or removing the shield from the item having a radio frequency chip, whereby adhering the shield to the item places the shield in sufficiently close proximity to the radio frequency chip to create interference with radio frequency waves transmitted or received by the radio frequency chip, thereby resists reading the radio frequency chip, and removing the shield from the item moves the shield sufficiently far away from the radio frequency chip to permit reading the chip.
